(19) United States
(12) Patent Application Publication
(10) Pub. No.: US 2007/0092659 A1
(43) Pub. Date: Apr. 26, 2007

(54) Method for creating a smooth coating transition zone

(76) Inventors: Tamara J. Kluge, Burnt Hills, NY (US); Jeffrey Louis Palmer, Schenectady, NY (US); Robert Scott Shalvoy, Simpsonville, SC (US); John Francis Buonanno, Clifton Park, NY (US); James Michael Mason, Albany, NY (US)

Correspondence Address: CANTOR COLBURN, LLP, 55 GRIFFIN ROAD SOUTH, BLOOMFIELD, CT, 06002, US

(21) Appl. No.: 11/257,685

(22) Filed: Oct. 25, 2005

(51) Int. Cl. B05D 1/08; C23C 4/00

(52) U.S. Cl. 427/446

(57) ABSTRACT

Disclosed herein is a method comprising inclining a spray gun of a high velocity oxygen fuel device at an angle of 15 degrees to a perpendicular to a substrate; incrementally displacing the spray gun to an angle of 35 degrees to the perpendicular to the substrate; spraying a surface of the substrate with the spray gun during the displacing of the spray gun; and covering the substrate with a coating that has a smooth transition zone from a coated region of the substrate to a non-coated region of the substrate; wherein the coating provides erosion protection greater than or equal to that of a coating produced when the spray gun spray angle to the substrate is not varied during the spraying.

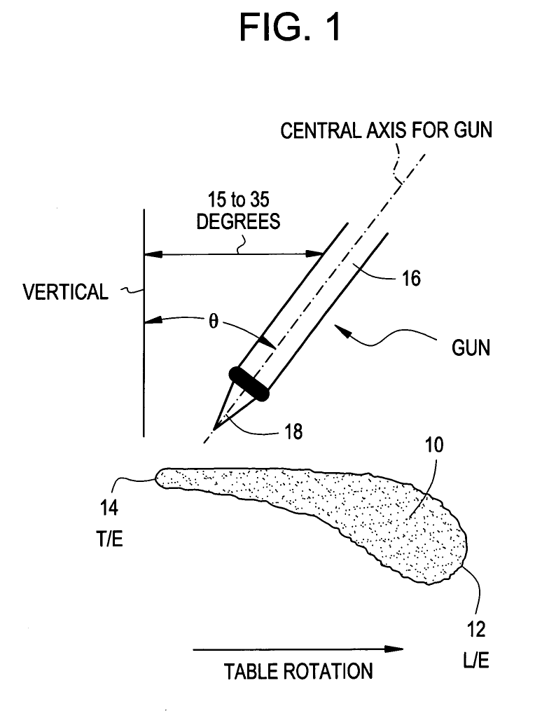

### BACKGROUND

Disclosed herein is an improved method for creating a smooth coating transition zone during a spray coating process. More specifically disclosed herein is an improved high velocity oxygen fuel coating process for the diaphragm steam path. The diaphragm steam path is comprised of several partitions arranged radially.

Diaphragm partitions used in steam turbines are often coated in order to increase resistance against erosion. The current coating process however results in an abrupt forward facing step in the steam path thereby causing a negative performance impact. The forward facing step has a height of about 10 mils (about 250 micrometers) and is often removed by subjecting the diaphragm to additional grinding. The additional grinding is both time-consuming and expensive. The grinding step also increases the cycle time for production. When the grinding is accomplished manually, it has the potential to result in additional damage and adds variability to the end product, which also increases cycle time and cost and decreases performance.

It is therefore desirable to develop a coating process that eliminates the formation of the step and provides a smooth transition from the coated surfaces of the diaphragm partitions to the uncoated surfaces while maintaining the current level of erosion protection.

### SUMMARY

Disclosed herein is a method comprising inclining a spray gun of a high velocity oxygen fuel device at an angle of 15 degrees to a perpendicular to a substrate; incrementally displacing the spray gun to an angle of 35 degrees to the perpendicular to the substrate; spraying a surface of the substrate with the spray gun during the displacing of the spray gun; and covering the substrate with a coating that has a smooth transition zone from a coated region of the substrate to a non-coated region of the substrate; wherein the coating provides erosion protection greater than or equal to that of a coating produced when the spray gun spray angle to the substrate is not varied during the spraying.

Disclosed herein too is a method comprising inclining a spray gun of a high velocity oxygen fuel device at an angle of 15 degrees to a perpendicular to a substrate; incrementally displacing the spray gun to an angle of 35 degrees to the perpendicular to the substrate; spraying a surface of the substrate with the spray gun during the displacing of the spray gun; and covering the substrate with a coating; wherein the coating has a transition zone that is smoother than the transition zone that is achieved when the spray gun spray angle to the substrate is not varied during the spraying; and wherein the coating provides erosion protection greater than or equal to that of a coating produced when the spray gun spray angle to the substrate is not varied during the spraying.

### DETAILED DESCRIPTION OF FIGURES

The FIGURE displays an exemplary schematic depicting the spray gun of the high velocity oxygen fuel device and the angle of displacement of the spray gun during the deposition of the coating on the substrate.

### DETAILED DESCRIPTION

In the following description, like reference characters designate like or corresponding parts throughout the several views shown in the figures. It is also understood that terms such as “top”, “bottom”, “outward”, “inward”, and the like are words of convenience and are not to be construed as limiting terms. It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity).

Disclosed herein is a method of coating a substrate that produces a smooth transition between the coated surfaces and the uncoated surfaces of the substrate. In one embodiment the substrate can be a diaphragm partition that is used in turbines. The method advantageously comprises using a high velocity oxygen fuel coating process wherein the spray gun (from which the coating composition is sprayed) is displaced through an angle of about 15 degrees to about 35 degrees to a perpendicular drawn to a surface of the substrate. The method enables the formation of a smooth transition zone wherein the coating is tapered from a height of 0 to about 250 micrometers over a distance of about 100 mils (2,500 micrometers) to about 300 mils (7,500 micrometers).

In the case of a diaphragm partition for a turbine, since the formation of steps in the coating or at the initial interface between the diaphragm partition surface and the coating is eliminated by this method, it advantageously avoids tripping of the steam flow while at the same time maintaining the current level of erosion protection. Additionally, hand grinding of the surfaces is eliminated.

The FIGURE depicts one exemplary embodiment of a system for coating the diaphragm partitions. With reference now to the FIGURE, a partition 10 comprising a leading edge 12 and a trailing edge 14 is placed on a rotary table during a high velocity oxygen fuel coating process. During the process, a spray gun 16 having a nozzle 18 is used to spray the surface with the coating composition. As can be seen from the FIGURE, the high velocity spray gun is displaced through an angle of about 15 degrees to about 35 degrees to a perpendicular to the surface of the diaphragm partition during the spray process. If the surface of the diaphragm partition is placed horizontally as depicted in the FIGURE, then the perpendicular to the surface is a vertical line. The angle θ between the vertical and the spray gun is measured from the vertical to the central axis of the spray gun as shown in the FIGURE.

In one embodiment, the high velocity spray gun is displaced through an angle of about 17 degrees to about 33 degrees to a perpendicular to the surface of the diaphragm partition during the spray process. In another embodiment, the high velocity gun is displaced through an angle of about 19 degrees to about 31 degrees to a perpendicular to the surface of the diaphragm partition during the spray process. In yet another embodiment, the high velocity gun is displaced through an angle of about 20 degrees to about 30 degrees to a perpendicular to the surface of the diaphragm partition during the spray process.

The spray gun is displaced through the angle from about 15 degrees to about 35 degrees to the perpendicular in increments of about 0.5 degrees to about 5 degrees to provide a tapered transition zone of 0 to 250 micrometers over a length of about 2,500 micrometers to about 7,500 micrometers. In another embodiment, the spray gun traverses the angle from about 15 degrees to about 35 degrees to the perpendicular in increments of about 1 degree to about 4 degrees. In yet another embodiment, the spray gun traverses the angle from about 15 degrees to about 35 degrees to the perpendicular in increments of about 1.5 degrees to about 3 degrees. An exemplary method of traveling comprises increments of about 2 degrees.

As noted above, the tapered transition zone has a height that varies from 0 to a maximum height of about 250 micrometers over a length of about 2,500 micrometers to about 7,500 micrometers. The term “maximum height” is used to indicate the maximum height of the taper and is not the maximum height achievable during the coating process. The tapered transition zone can therefore have a maximum height of less than or equal to about 250 micrometers, such as, for example, less than or equal to about 150 micrometers, less than or equal to about 100 micrometers or less than or equal to about 50 micrometers, or alternatively can have a maximum height that is greater than or equal to about 250 micrometers, such as, for example, greater than or equal to about 300 micrometers, greater than or equal to about 400 micrometers, or greater than or equal to about 500 micrometers. In one embodiment, the maximum height of the transition zone can be greater than or equal to about 1,000 micrometers.

Similarly, the length of the transition zone is not restricted to a minimum distance of 2,500 micrometers or a maximum distance of 7,500 micrometers. The minimum distance can be less than 2,500 micrometers such as, for example, less than or equal to about 2,000 micrometers, less than or equal to about 1,500 micrometers or less than or equal to about 1,000 micrometers. The maximum distance can be greater than 7,500 micrometers such as, for example, greater than or equal to about 9,000 micrometers, greater than or equal to about 10,000 micrometers or greater than or equal to about 12,500 micrometers.

During the deposition of the coating, the table is rotated at a speed of about 10 to about 50 revolutions per minute (rpm). In one embodiment, the table is rotated at a speed of about 12 to about 30 rpm. In another embodiment, the table is rotated at a speed of about 15 to about 20 rpm. An exemplary speed of rotation is 16 to 17 rpm.

During the deposition of the coating, the spray gun travels in a straight line from a fixed outside diameter to a fixed inside diameter while the table and thus the diaphragm rotate. The outside and inside diameters are set at the outside and inside edges of the partition. The rate of travel of the spray gun is about 6 centimeters/minute to about 15 centimeters/minute. An exemplary rate of travel is about 12 centimeters/minute. During the travel of the spray gun, 1 mil (2.54 micrometers) of coating is applied at each spray angle before the spray gun is displaced to the next angle. The trailing edge of the previous partition is used as a mask.

The spray guns on the high velocity oxygen fuel apparatus use different methods to achieve high velocity spraying. One method is basically a high pressure water cooled HVOF combustion chamber and long nozzle. Fuel (kerosene, acetylene, propylene or hydrogen) and oxygen are fed into the chamber, combustion produces a hot high pressure flame which is forced down a nozzle increasing its velocity. Powder used for the coating of the diaphragm partition may be fed axially into the HVOF combustion chamber under high pressure or fed through the side of a laval type nozzle where the pressure is lower. Another method uses a simpler system of a high pressure combustion nozzle and an air cap (not shown). Fuel gas (propane, propylene or hydrogen) and oxygen are supplied at high pressure, combustion occurs outside the nozzle but within an air cap (not shown) supplied with compressed air. The compressed air pinches and accelerates the flame and acts as a coolant for the HVOF gun. Powder is fed at high pressure axially from the centre of the nozzle.

The high velocity oxygen fuel thermal spray process uses a gas velocity of about 1,800 to about 2,500 meters/second and a particle velocity of about 450 meters/second to about 700 meters/second. In one embodiment, the high velocity oxygen fuel thermal spray process uses a spray velocity of about 500 meters/second to about 675 meters/second. In another embodiment, the high velocity oxygen fuel thermal spray process uses a spray velocity of about 525 meters/second to about 650 meters/second. In yet another embodiment, the high velocity oxygen fuel thermal spray process uses a spray velocity of about 550 meters/second to about 625 meters/second. An exemplary gas velocity is about 2,100 meters/second and an exemplary particle velocity is about 600 meters/second.

In one embodiment, in one manner of carrying out the method, the surface to be coated is first grit blasted with alumina grit. The air supply used for the grit blasting is free from contaminants such as water, oil, or the like. The diaphragm is preheated to 150 to 200° F. using propane and air torches. During the preheating process the diaphragm is kept free from soot deposits. The diaphragm may be rotated during the preheating process to provide uniform heating. During the coating process using the high velocity oxygen fuel spraying, the central axis of the spray gun is tilted at approximately 15 degrees from the vertical to the partition trailing edge. The spray gun is tilted away from the throat opening to avoid a coating build-up in the nozzle area. During the coating, the travel of the spray gun is generally adjusted to apply no more than one mil of coating per pass. The spray angle may be adjusted after approximately one mil of coating was applied at the previous angle. The spray process may be interrupted for inspections if desired. It is generally desirable to prevent the diaphragm temperature from exceeding 400° F. during the spraying.

As noted above, this method is advantageous in that it provides a smooth transition zone from a coated region to a non-coated region without a significant step in thickness as is observed in currently available commercial processes while maintaining the current level of erosion protection.

The present disclosure is illustrated by the following non-limiting example.

### EXAMPLE

The example was performed to demonstrate the advantage of coating the partitions of a diaphragm of a turbine using the disclosed method. In this example a powdered material was applied to the diaphragms via HVOF (High Velocity Oxy-Fuel) spraying. The powdered material is a chromium carbide-nickel chromium powder alloy with a composition of 68 to 78 wt. % chromium and 14 to 22 wt. % nickel. The process parameters are as follows:

The spray distance was about 8 inches. The powder feed rate was about 5 lbs/hr (2.27 kilograms/hour). The powder was preheated to a temperature of about 200 to 300° F. The diaphragm was maintained at a temperature of about 200 to 300° F. The table rotational speed during the coating process was 16 to 17 revolutions per minute (rpm). The gases used were oxygen, hydrogen and air having pressures as indicated in the Table 1.

TABLE 1

| | Gas | | |
|---|---|---|---|
| | Oxygen | Hydrogen | Air |
| Pressure (psi) | 170 | 140 | 100 |
| Flow (FMR) | 32 | 64 | 44 |
| SCFH | 489 | 1473 | 785 |

The carrier gas used for the powder was nitrogen. The carrier gas supply pressure was regulated at 175 pounds per square inch (psi)+/−5 psi. The carrier gas pressure at the pressure feeder was 150 psi +/−2 psi. The carrier gas flow was 55 FMR +/−2 FM. The number of cycles used was 20 to 40.

The properties of the coating are shown in the Table 2 below. In the Table 2, a comparative sample that uses the conventional process is also shown. In the comparative sample, the spray gun is permanently inclined at an angle of 15 degrees to the vertical and the spraying is conducted. The spray gun spray angle does not vary as in the disclosed process.

TABLE 2

| Sample | Transition | Angle | | | | | | | | | | Std. | | |
|---|---|---|---|---|---|---|---|---|---|---|---|---|---|---|
| # | (mils) | (deg) | Micro hardness Knoop 100 gram Parallel | | | | | | | | Avg. | Dev. | Min | Max |
| Existing Process | | | | | | | | | | | | | | |
| 1 | 37.73 | 15 | 1080 | 1074 | 859 | 1182 | 975 | 889 | 898 | 998 | 998 | 113 | 859 | 1182 |
| Disclosed Process | | | | | | | | | | | | | | |
| 2 | 198.5 | 15-35 | 975 | 1001 | 960 | 950 | | | | | 972 | 22 | 950 | 1001 |
| 3 | 198.5 | 15-35 | 975 | 960 | 950 | 1034 | | | | | 980 | 38 | 950 | 1034 |
| 4 | 198.5 | 15-35 | 1039 | 898 | 985 | 1051 | | | | | 993 | 70 | 898 | 1051 |
| 5 | 198.5 | 15-35 | 1045 | 921 | 1034 | 955 | | | | | 989 | 60 | 921 | 1034 |

From Table 2, it can be seen that the transition zone of the disclosed process is longer than that for the existing process, thus producing a smoother transition from the uncoated surface of the substrate to the coated surface of the substrate. From Table 2, it can also be seen that there is a greater consistency in the hardness of the samples manufactured by the disclosed process. The standard deviation for the existing process is 2 to 3 times the standard deviation for the disclosed process.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A method comprising:
inclining a spray gun of a high velocity oxygen fuel device at an angle of 15 degrees to a perpendicular to a substrate;
incrementally displacing the spray gun to an angle of 35 degrees to the perpendicular to the substrate;
spraying a surface of the substrate with the spray gun during the displacing of the spray gun; and
covering the substrate with a coating that has a smooth transition zone from a coated region of the substrate to a non-coated region of the substrate; wherein the coating provides erosion protection greater than or equal to that of a coating produced when the spray gun spray angle to the substrate is not varied during the spraying.

2. The method of claim 1, wherein the substrate is a diaphragm partition of a turbine.

3. The method of claim 1, wherein the spray gun is displaced through the angle from about 15 degrees to about 35 degrees to the perpendicular in increments of about 0.5 degrees to about 5 degrees.

4. The method of claim 1, wherein the spray gun is displaced through the angle from about 15 degrees to about 35 degrees to the perpendicular in increments of about 2 degrees.

5. The method of claim 1, wherein the displacing of the spray gun is effective in providing a tapered transition zone of up to 250 micrometers in height over a length of about 2,500 micrometers to about 7,500 micrometers.

6. The method of claim 1, wherein the covering of the substrate is accomplished at a rate of about 25.4 micrometers of coating per pass of the spray gun across the substrate.

7. The method of claim 1, wherein an angle of inclination of the spray gun is adjusted after approximately 25.4 micrometers of coating is applied to the substrate at a previous angle of inclination.

8. The method of claim 1, wherein the coating is a chromium carbide-nickel chromium powder alloy that comprises a composition of about 68 to about 78 wt % chromium and about 14 to about 22 wt % nickel based on the total weight of the chromium carbide-nickel chromium powder alloy.

9. The method of claim 1, wherein the coating has a transition zone that is smoother than the transition zone that is achieved when the spray gun spray angle to the substrate is not varied during the spraying.

10. A method comprising:
inclining a spray gun of a high velocity oxygen fuel device at an angle of 15 degrees to a perpendicular to a substrate;
incrementally displacing the spray gun to an angle of 35 degrees to the perpendicular to the substrate;
spraying a surface of the substrate with the spray gun during the displacing of the spray gun; and
covering the substrate with a coating; wherein the coating has a transition zone that is smoother than the transition zone that is achieved when the spray gun spray angle to the substrate is not varied during the spraying; and wherein the coating provides erosion protection greater than or equal to that of a coating produced when the spray gun spray angle to the substrate is not varied during the spraying.
